(19) United States
(12) Patent Application Publication
(10) Pub. No.: US 2017/0325488 A1
(43) Pub. Date: Nov. 16, 2017

(54) Popcorn Popping System

(71) Applicant: Garry Stopa, Abbotsford (CA)

(72) Inventor: Garry Stopa, Abbotsford (CA)

(21) Appl. No.: 15/153,808

(22) Filed: May 13, 2016

(51) Int. Cl. A23L 7/174

(52) U.S. Cl. CPC A23L 7/174; A23V 2002/00

(57) ABSTRACT

A popcorn popping system improves performance of a hot air popcorn popper. The system includes an air popper that pops popcorn thereby facilitating the popcorn to be consumed. A bowl is positioned on the air popper to contain the popcorn when the popcorn is popped. A screen is positioned on the bowl. The screen inhibits the popcorn from escaping the bowl when the popcorn is popped.

### BACKGROUND OF THE DISCLOSURE

### Field of the Disclosure

The disclosure relates to popping devices and more particularly pertains to a new popping device for improving performance of a hot air popcorn popper.

### SUMMARY OF THE DISCLOSURE

An embodiment of the disclosure meets the needs presented above by generally comprising an air popper that pops popcorn thereby facilitating the popcorn to be consumed. A bowl is positioned on the air popper to contain the popcorn when the popcorn is popped. A screen is positioned on the bowl. The screen inhibits the popcorn from escaping the bowl when the popcorn is popped.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an exploded perspective view of a popcorn popping system according to an embodiment of the disclosure.

FIG. 2 is a top view of a screen of an embodiment of the disclosure.

FIG. 3 is a right side cut-away view of an embodiment of the disclosure.

FIG. 4 is a perspective phantom view of an embodiment of the disclosure.

### DESCRIPTION OF THE PREFERRED EMBODIMENT

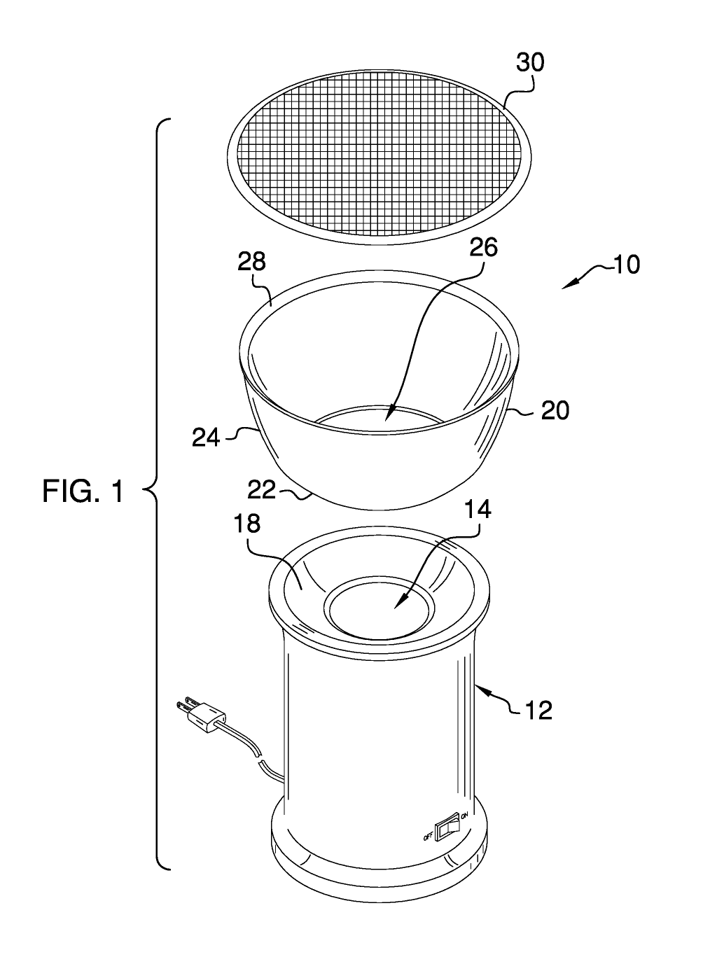

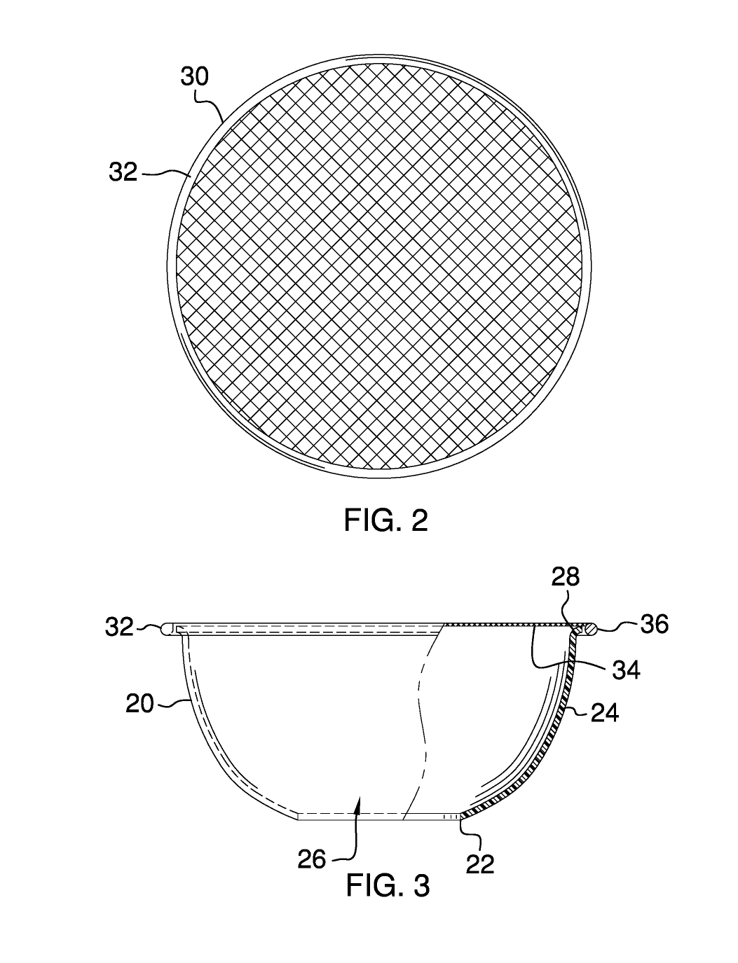

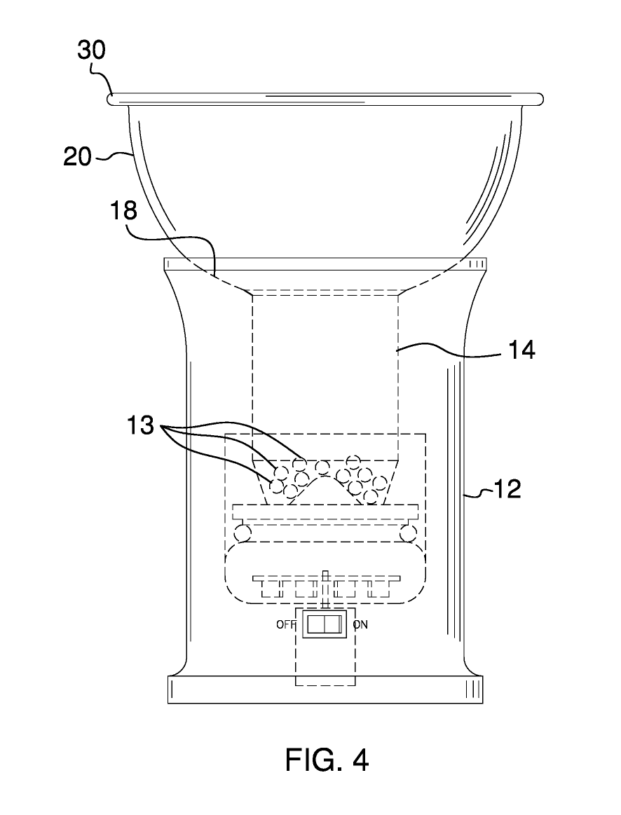

With reference now to the drawings, and in particular to FIGS. 1 through 4 thereof, a new popping device embodying the principles and concepts of an embodiment of the disclosure and generally designated by the reference numeral 10 will be described.

As best illustrated in FIGS. 1 through 4, the popcorn popping system 10 generally comprises an air popper 12 that pops popcorn 13 thereby facilitating the popcorn 13 to be consumed. The air popper 12 has a heat chamber 14 and a heating coil 16 that is positioned within the heat chamber 14. The air popper 12 has a top end 18 and the top end 18 is open into the heat chamber 14. The air popper 12 may be a hot air pop corn popper or the like. The top end 18 may be concavely arcuate to form a dish.

A bowl 20 is provided. The bowl 20 may be positioned on the air popper 12. Thus, the bowl 20 may contain the popcorn 13 when the popcorn 13 is popped. The bowl 20 has a bottom wall 22 and an outer wall 24. The bottom wall 22 has an opening 26 extending therethrough. The bottom wall 22 is positioned on the top end 18 such that the opening 26 is aligned with the heat chamber 14. The outer wall 24 has a distal edge 28 with respect to the bottom wall 22.

A screen 30 is provided. The screen 30 is positioned on the bowl 20. Thus, the screen 30 inhibits the popcorn 13 from escaping the bowl 20 when the popcorn 13 is popped. The screen 30 is positioned on the distal edge 28 of the bowl 20. The screen 30 has an outer edge 32 and a lower side 34. A gasket 36 is coupled to the lower side 34 and the gasket 36 is coextensive with the outer edge 32. The distal edge 28 of the bowl 20 sits inside of the gasket 36 when the screen 30 is positioned on the bowl 20. Thus, the gasket 36 inhibits the screen 30 from sliding off of the bowl 20.

In use, the popcorn 13 is poured into the heat chamber 14. The bowl 20 is positioned on the top end 18 and the screen 30 is positioned on the bowl 20. The air popper 12 is turned on the popcorn 13 is popped. The popcorn 13 is deposited in the bowl 20 when the popcorn 13 is popped. The screen 30 inhibits the popped popcorn 13 from escaping the bowl 20. The opening 26 in the bowl 20 facilitates un-popped popcorn 13 to fall back into the heat chamber 14. Thus, the un-popped popcorn 13 is popped. The bowl 20 is removed from the air popper 12 when the popcorn 13 is popped and the popcorn 13 is consumed.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A popcorn popping system comprising:
an air popper being configured to cook popcorn thereby facilitating the popcorn to be consumed;
a bowl being positioned on said air popper wherein said bowl is configured to contain the popcorn when the popcorn is popped; and
a screen being positioned on said bowl wherein said screen is configured to inhibit the popcorn from escaping said bowl when the popcorn is popped.

2. The system according to claim 1, wherein said air popper has a heat chamber and a heating coil being positioned within said heat chamber, said air popper having a top end, said top end being open into said heat chamber.

3. The system according to claim 1, wherein:
said air popper has a top end and a heat chamber; and
said bowl has a bottom wall and an outer wall, said bottom wall having an opening extending therethrough, said bottom wall being positioned on said top end such that said opening is aligned with said heat chamber, said outer wall having a distal edge with respect to said bottom wall.

4. The system according to claim 3, wherein said screen being positioned on said distal edge of said bowl.

5. A popcorn popping system comprising:
an air popper being configured to cook popcorn thereby facilitating the popcorn to be consumed, said air popper having a heat chamber and a heating coil being positioned within said heat chamber, said air popper having a top end, said top end being open into said heat chamber;
a bowl being positioned on said air popper wherein said bowl is configured to contain the popcorn when the popcorn is popped, said bowl having a bottom wall and an outer wall, said bottom wall having an opening extending therethrough, said bottom wall being positioned on said top end such that said opening is aligned with said heat chamber, said outer wall having a distal edge with respect to said bottom wall; and
a screen being positioned on said bowl wherein said screen is configured to inhibit the popcorn from escaping said bowl when the popcorn is popped, said screen being positioned on said distal edge of said bowl.
